(19) United States
(12) Patent Application Publication
(10) Pub. No.: US 2009/0089846 A1
(43) Pub. Date: Apr. 2, 2009

(54) System and method providing enhanced features for streaming video-on-demand

(76) Inventors: Meng Wang, Vancouver (CA); Jian Wang, Vancouver (CA); Ying Luo, Mississauga (CA); Ignatius Cheng, Burnaby (CA); Peter Koat, Surrey (CA)

Correspondence Address: K&L Gates LLP, STATE STREET FINANCIAL CENTER, One Lincoln Street, BOSTON, MA, 02111-2950, US

(21) Appl. No.: 10/581,845

(22) PCT Filed: Dec. 6, 2004
(86) PCT No.: PCT/CA04/02082

§ 371 Date: Sep. 22, 2008

(30) Foreign Application Priority Data
Dec. 4, 2003 (US) 10/727857

(51) Int. Cl. H04N 7/173

(52) U.S. Cl. 725/98

(57) ABSTRACT

The present invention provides a system and method for providing enhanced features for streaming video-on-demand systems. The system comprises a media server and a client player, wherein a user can select a desired video for transmission from the media server to the client player for subsequent display for the user via the client player. The system comprises a mechanism that enables a user to interactively select a desired new starting point for the display of the selected video signal. The mechanism is provided by a first and second series of searchable index frames, wherein the first series is generated by the media server during transmission of the selected video signal and the second series is generated by the client player during receipt of the selected video signal. Upon receipt by the client player of the desired new starting point, the first or second series are accessed in order to identify a required searchable index frame that best represents the desired new starting point. Display of the video by the client player subsequently commences from the required searchable index frame.

### FIELD OF THE INVENTION

The present invention relates generally to systems for providing steaming video-on-demand to end-users. More specifically the present invention relates to the provision of enhanced features to viewers of video-on-demand over Internet Protocol (IP) based networks.

### BACKGROUND

Consumer entertainment services, including video-on-demand (VOD) and personal video recorder (PVR) services can be delivered using conventional communication system architectures. In conventional digital cable systems, a channel is dedicated to the user for the duration of the video. VOD services that attempt to emulate the display of a digital versatile/video disk (DVD) are delivered from centralized video servers that are large, super-computer style processing machines. These machines are typically located at a metro services delivery center supported on a cable multiple service operator's (MSO) metropolitan area network. The consumer selects the video from a menu and the video is streamed out from a video server. The video server encodes the video on the fly and streams out the content to a set-top box that decodes it on the fly; no caching or local storage is required at the set-top box. In such centralized video server architecture, the number of simultaneous users is constrained by the capacity of the video server. This solution can be quite expensive and difficult to scale. “Juke-box” style DVD servers suffer from similar performance and scalability problems.

Video-on-demand services have been known in hotel television systems for several years. Video-on-demand services allow users to select programs to view and have the video and audio data of those programs transmitted to their television sets. Examples of such systems include: U.S. Pat. No. 6,057,832 disclosing a video-on-demand system with a fast play and a regular play mode; U.S. Pat. No. 6,055,314 which discloses a system for secure purchase and delivery of video content programs over distribution networks and DVDs involving downloading of decryption keys from the video source when a program is ordered and paid for; U.S. Pat. No. 6,049,823 disclosing an interactive video-on-demand to deliver interactive multimedia services to a community of users through a LAN or TV over an interactive TV channel; U.S. Pat. No. 6,025,868 disclosing a pay-per-play system including a high-capacity storage medium; U.S. Pat. No. 5,945,987 teaching an interactive video-on-demand network system that allows users to group together trailers to review at their own speed and then order the program directly from the trailer; U.S. Pat. No. 5,935,206 teaching a server that provides access to digital video movies for viewing on demand using a bandwidth allocation scheme that compares the number of requests for a program to a threshold and then, under some circumstances of high demand makes another copy of the video movie on another disk where the original disk does not have the bandwidth to serve the movie to all requesters; U.S. Pat. No. 5,926,205 teaching a video-on-demand system that provides access to a video program by partitioning the program into an ordered sequence of N segments and provides subscribers concurrent access to each of the N segments; U.S. Pat. No. 5,802,283 teaching a public switched telephone network for providing information from multimedia information servers to individual telephone subscribers via a central office that interfaces to the multimedia server(s) and receives subscriber requests and including a gateway for conveying routing data and a switch for routing the multimedia data from the server to the requesting subscriber over first, second and third signal channels of an ADSL link to the subscriber.

U.S. Pat. No. 6,055,560 disclosing an interactive video-on-demand system that supports functions normally only found on a VCR such as rewind, stop, fast forward. In addition, U.S. Pat. No. 6,020,912 disclosing a video-on-demand system having a server station and a user station with the server stations being able to transmit a requested video program in normal, fast forward, slow, rewind or pause modes. Both of these patents define features which enable one to view video at an accelerated forward rate, or a reverse rate for example, as it typically provided by a video cassette recorder.

Prior art streamed video on demand (SVOD) systems and a growing body of developing international standards exist for the provision of digital video content to end users. Current implementations of these systems are expensive, rely upon proprietary or inaccessible networks or cable systems and creating the net result of systems that do not provide the combination of attractive price, meaningful functionality and dependable delivery over existing networks.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method providing enhanced features for streaming video-on-demand. In accordance with one aspect of the present invention there is provided a video-on-demand system enabling a user to modify play parameters of a selected video signal, said system comprising: a media server for transmitting the selected video signal, said media server generating a first series of searchable index frames during transmission of the selected video signal, said media server storing said first series thereon; a client player for receiving and displaying the selected video signal, said client player generating and storing a second series of searchable index frames thereon, said client player accessing said first series or said second series and obtaining a required searchable index frame therefrom upon receipt of a request by the user to modify the play parameters, said required searchable index frame providing a new starting point for display of the selected video signal, said media server and said client player being operatively connected by a communication network.

In accordance with another aspect of the present invention there is provided a method for enabling a user to modify play parameters of a selected video signal in a video-on-demand system, said method comprising the steps of: receiving by a media player, a request for the selected video signal from a client player; transmitting by said media player, said selected video signal to the client player; generating and storing a first series of searchable index frames by the media player while transmitting; receiving and displaying said selected video signal by the client player; generating and storing a second series of searchable index frames by the client player while receiving and displaying; receiving by the client player, a request to modify play parameters of the selected video signal from the user; searching said first series or second series for a required searchable index frame, said required searchable index frame providing a new starting point for displaying said selected video signal; displaying said selected video signal from said new starting point.

### BRIEF DESCRIPTION OF THE FIGURES

FIG. 1 illustrates the general structure the streaming video-on-demand system according to one embodiment of the present invention.

FIG. 2 is a flow diagram of the streaming video-on-demand system according to one embodiment of the present invention.

FIG. 3 is a block diagram defining the generation of a movie database and a feature database according to one embodiment of the present invention.

FIG. 4 is a block diagram defining the operation of the user account module according to one embodiment of the present invention.

FIG. 5 is a block diagram defining on-line intelligent retrieval according to one embodiment of the present invention.

FIG. 6 is a block diagram defining the process of streaming movie content to a client player from the media server according to one embodiment of the present invention.

FIG. 7 is a block diagram defining the process of data communication between the media server and the client player according to one embodiment of the present invention.

FIG. 8 is a block diagram defining the movie playback and control mechanism according to one embodiment of the present invention.

FIG. 9 illustrates a streaming sequence according to one embodiment of the present invention.

FIG. 10 illustrates a streaming sequence according to another embodiment of the present invention.

FIG. 11 illustrates a streaming sequence according to another embodiment of the present invention.

FIG. 12 illustrates a strategy for deriving a S-frame from an I-frame according one embodiment of the present invention.

FIG. 13 illustrates a strategy for deriving a S-frame from a P-frame according to one embodiment of the present invention.

FIG. 14 illustrates a strategy for deriving a S-frame from an I-frame in decoding according to one embodiment of the present invention.

FIG. 15 illustrates a strategy for deriving a S-frame from a P-frame in decoding according to one embodiment of the present invention.

FIG. 16 illustrates a streaming sequence according to one embodiment of the present invention identifying the generation of an index sequence during coding and decoding of the streaming sequence.

### DETAILED DESCRIPTION OF THE INVENTION

The present invention provides a system and method for providing enhanced features for streaming video-on-demand systems. The system comprises a media server and a client player, wherein a user can select a desired video for transmission from the media server to the client player for subsequent display for the user via the client player. The system comprises a mechanism that enables a user to interactively select a desired new starting point for the display of the selected video signal. The mechanism is provided by a first and second series of searchable index frames, wherein the first series is generated by the media server during transmission of the selected video signal and the second series is generated by the client player during receipt of the selected video signal. Upon receipt by the client player of the desired new starting point, the first or second series are accessed in order to identify a required searchable index frame that best represents the desired new starting point. Display of the video by the client player subsequently commences from the required searchable index frame.

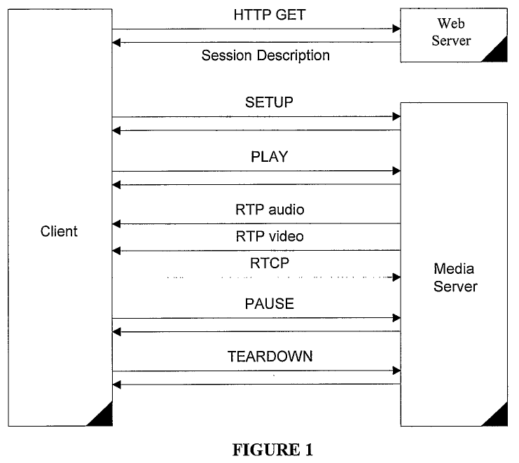

FIG. 1 illustrates the general structure of the system according to one embodiment of the present invention. Initially, the end user issues an HTTP GET command to the web server to start a Real Time Streaming Protocol (RTSP) session. The web server, after receiving and processing the connection request can send back to the end user a session description. If the web server agrees to establish the connection, it can start a client player, which can issue a SETUP request to the media server and a connection can be established between the client player and the media server. As a result, data communication is ready and the user may choose to play/pause the media subsequently streamed from the media server. Simultaneously, the client player may send back some Real-time Transport Control Protocol (RTCP) packets to give quality of service (QoS) feedback and support the synchronization of different media streams that can exist in embodiments of the present invention. These packets can convey information such as the session participant and multicast-to-unicast translators. At the conclusion of the session or upon end user request, the client player can close the connection by sending a TEARDOWN command to the media server; the media server will then close the connection.

For the streaming control, one embodiment of the present invention may use the Real Time Streaming Protocol (RTSP). Considering its popularity and quality, it is a suitable protocol to set up and control media delivery. For the actual data transfer, Internet Engineering Task Force (IETF) authored Real-time Transport Protocol (RTP) may be used. RTP is layered on top of TCP/IP or UDP and is effective for real-time data transmission.

For resources control, Resource ReserVation Protocol (RSVP) may be used to provide the QoS services to end users. When a client player sends a request to the web server for a movie with some quality requirements, the web server can decide if the resources for the requirements are available or not. If the resources are available, they can be reserved for media transmission from the media server to the client player; otherwise, the web server can notify the client that there are not enough resources to meet its requested requirements. In one embodiment of the present invention, the web server and the media server can be integrated into a single server.

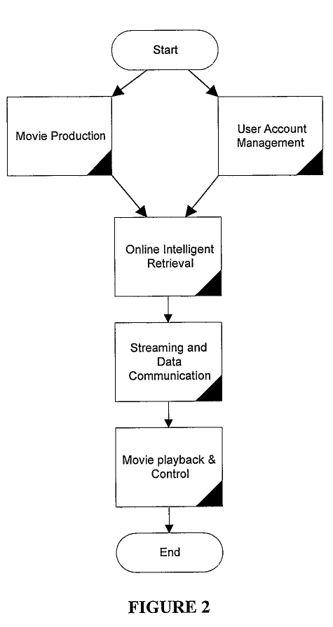

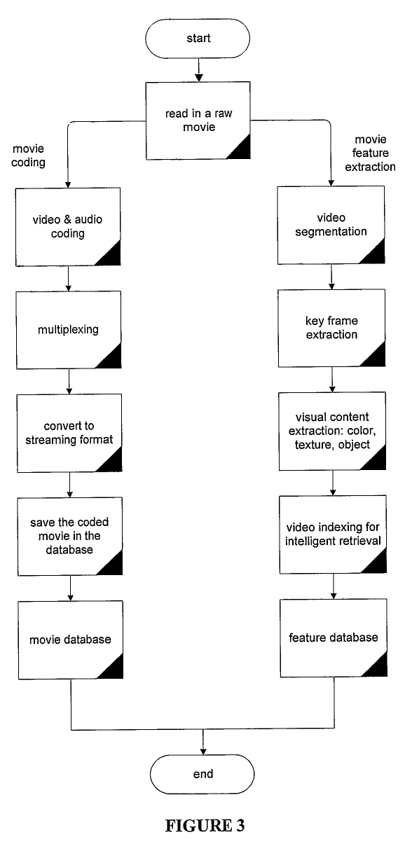

FIG. 2 illustrates the overall flow chart of the streaming video-on-demand system according to one embodiment of the present invention. The system comprises five modules: movie production, intelligent movie retrieval, movie streaming and data communication, movie playback, and user account management.

Movie production is the process used to generate a movie database for playback and a feature database for movie retrieval and this can be performed by the movie production module. When new movies come, they can go through two processes. One is an encoding process, where the movie content is encoded and converted to a bit-stream suitable for streaming. The other is a preprocessing step, where some semantic contents of the movie are extracted, such as keywords, movie category, scene change information, story units, important objects or other features for example.

Another module is the user account management, which comprises a user registration control and a user account information database. The user registration provides an interface for new users to register and existing users to log on. User account information database saves all the user information, including credit card number, user account number, balance and other user information, for example. As would be known, this type of information should be secured against intrusion during both transmission and storage.

After movie encoding production, a movie database is available for customers (end users) to browse and this is provided by the intelligent movie retrieval module. However, if the database contains tens of thousands of movies, it is difficult to find a wanted movie. Therefore, a search engine can be required to enhance the efficiency of the system through the use of extracted features that can be word identifiers or image identifiers. For example, the search can be based on movie title, movie features, and/or important objects. Movie title search is quite obvious and can be implemented easily. Movie feature search means searching the feature database to find movies with certain, fundamental features. The features may include color, texture, motion, shape, or other features for example as would be readily understood. A third search criteria may be to find movies with certain important objects, such as featured performers, director or other criteria, for example.

Once an end user selects a movie, the movie streaming and data communication module can be started. Streaming and data communication is a process that commences with opening a connection between the client player and the media server and subsequently sending the compressed movie file to the client player for playback. The file is in a format suitable for streaming. By using streaming, the client player can start to play the movie after buffering a certain number of frames, which is much more user friendly than downloading the file completely prior to commencing play of the movie.

The movie playback module is responsible for playing and controlling the playing of movie. Movie playback can be performed while streaming continues. At the same time, another thread can be maintained for the control information from the customer (end user). The control information can include play/stop/pause, fast forward/backward, and exit.

When a user chooses a movie to watch, the web server can activate the corresponding client player, which can communicate with the media server for the specific movie. Some configuration is required to enable the web server to recognize appropriate file extensions and call the corresponding client player.

The media server is important within the system and its responsibilities can include setting up connections with clients, transmitting data, and closing the connections with client players.

All movie files saved in the media server can be in streaming format. The data communication between a client player and the media server can use RTSP for control and RTP for actual data transmission. Software Development Kits (SDKs) from Real Network are available to convert files coded for the present invention into the standard streaming format. At the decoder side, the same SDKs can be used to convert the streaming data into a multiplexed bit stream.

Movie production is a procedure to convert video files into a streaming format. The production process of the present invention includes a video coding and conversion process and a content extraction process. The first process encodes a raw movie and converts the encoded file into a format suitable for streaming. In one embodiment, the system can use H.263+, AVC (H.264) or other codec for video coding and decoding and the system can use MP3, AAC+ or other codec for audio coding and decoding. Likewise, the multiplexing scheme used can be one of the MPEG standards. After encoding and multiplexing, the bit-stream is converted into a streaming format. The present invention may use some Real Producer SDKs to convert the bit-stream to a file in streaming format and the file can be saved in a movie database.

The content extraction process starts with video segmentation, where the scene changes are detected and a long movie is cut into small pieces. Within each scene change, one or more key frames are extracted. Key frames can be organized to form a storyboard and can also be clustered into units of semantic meaning, which can correspond to some stories in a movie. Visual features of the key frames can be computed, such as color, texture, and shape. The motion and object information within each scene change can also be computed. All this information can be saved in a movie feature database for movie database indexing and retrieval.

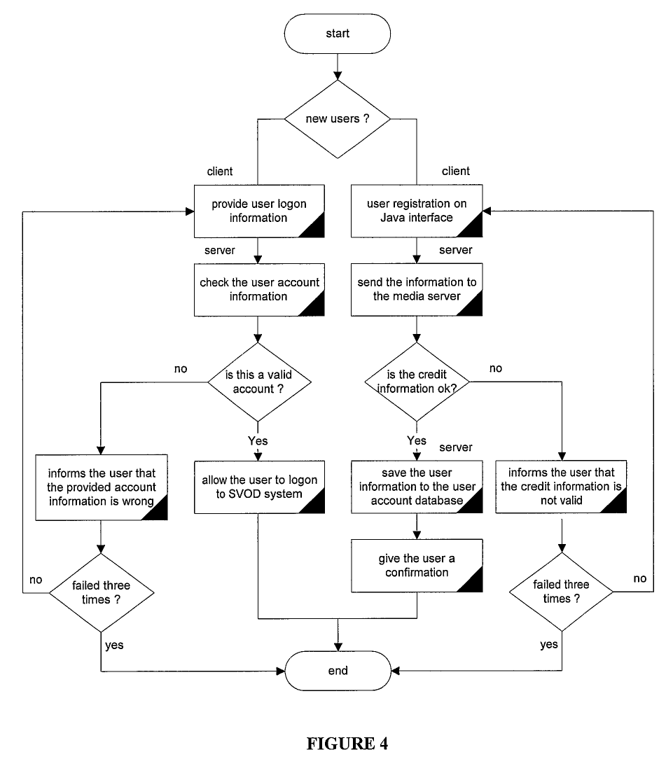

The user account management module, as illustrated in FIG. 4 is responsible for user registration and user account information management. User registration can be realized via a Java interface for example, where new users are required to provide some information and existing users can type in their user name and password. For a new user, the new account information needs to be entered and sent to the media server for confirmation. If the account information is acceptable, an account name and password can be generated and sent to the user. Otherwise, the user can be asked to reenter the account information. If the user fails three times, the module will exit, for example. For an existing user, a logon interface can appear for the user name and password. If the user name and password are acceptable, the user is allowed to browse the movie database and choose one or more movies to watch. Otherwise, the user is informed that the user name and/or password are not correct. The user can reenter the user name and password. If the user fails three times, the module will exit, for example.

FIG. 5 illustrates a flow chart for the function of the online intelligent retrieval module. This module displays the thumbnails of a selected set of movies. If a customer (end user) wants to search for a movie, several search criteria are available, such as movie title, keywords, important objects, feature-based search, and audio feature search. A feature database can be searched against the user-specified criteria and the thumbnails of the best matches in the movie database can be returned as the search result. The customer can then browse the thumbnails to get more detailed information or click them to playback a short clip. This module can allow users to find a set of movies that they like in a shortened time period.

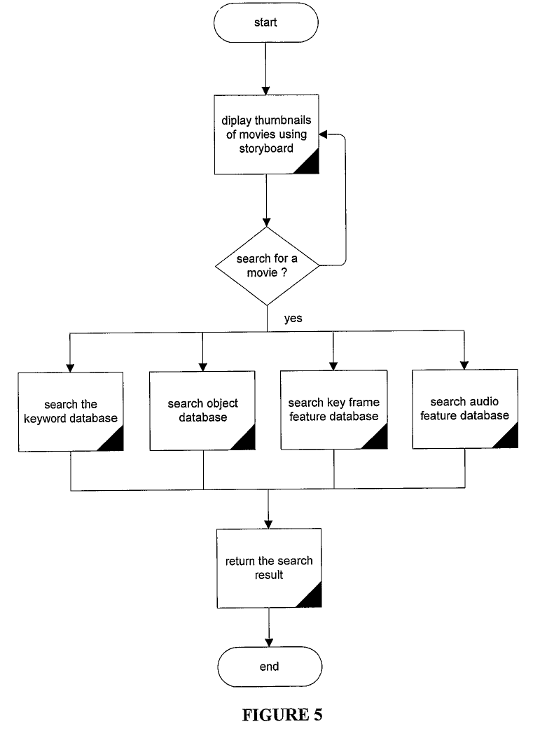

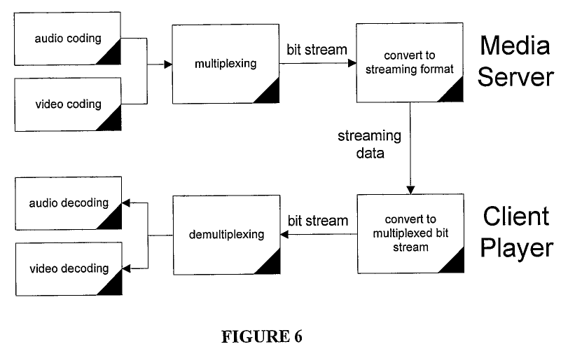

FIG. 6 shows the streaming process between the media server and client player. After video and audio coding, multiplexing is applied to generate a multiplexed bit-stream with timing information. Then the bit-stream is converted to the streaming format and sent to the client player. When the client player receives the bit-stream, the client player will convert it back to the multiplexed bit-stream, which will then be de-multiplexed and sent to audio and video decoders for playback.

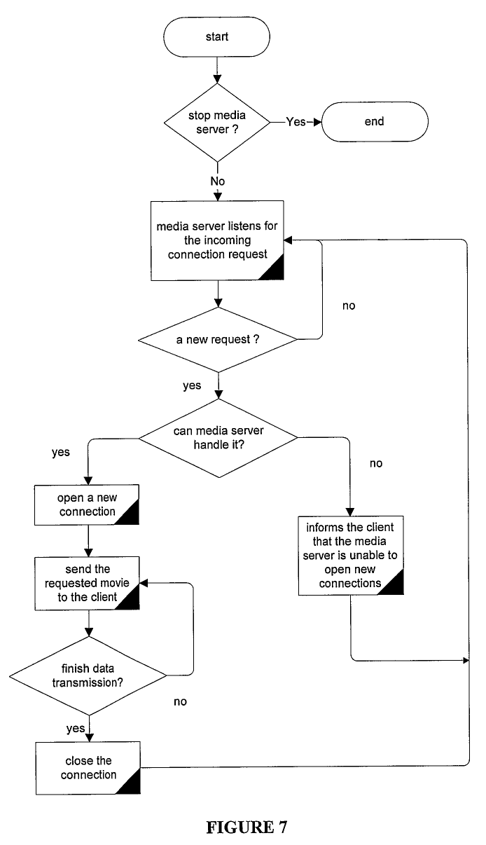

FIG. 7 shows the data communication between the media server and client player. If the media server does not receive a stop command, it will always check the incoming connection requests from the client players. When a new connection request comes in, the media server can check the available resources to see if it can handle this new request. If so, it can open a new connection and stream the requested movie to the client; otherwise, it can inform the client player that the media server is unable to process the request. After the movie is streamed to the client, the connection between the media server and the client can be closed so that the network bandwidth can be saved for other uses.

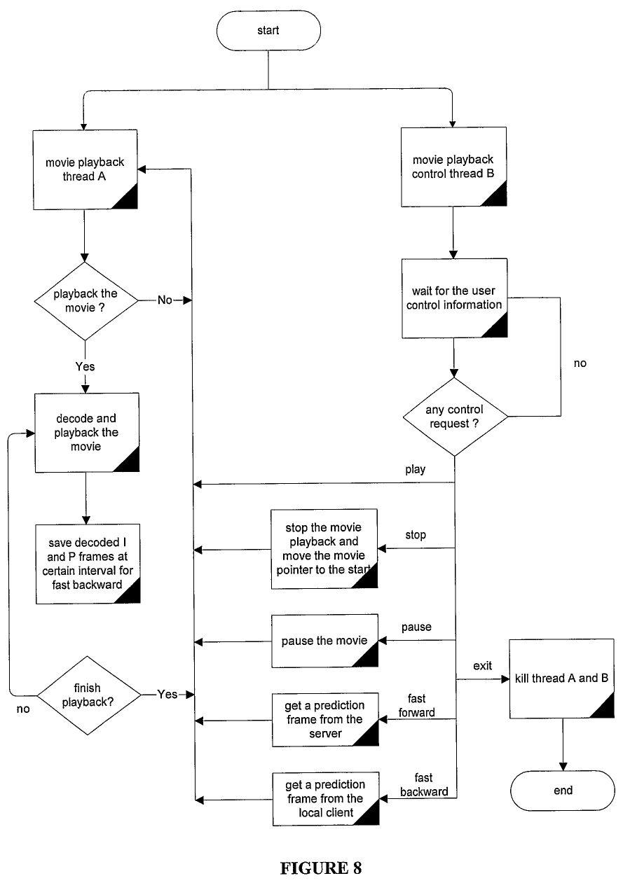

The movie playback and control module is illustrated in FIG. 8 and can have two threads associated therewith, threads A and B for example. Thread A decodes the compressed movie and plays it, and thread B accepts the control information from the end users via the client player. The control information can include play, stop/pause, fast forward/backward, and exit commands. Thread A checks if the current playback mode is set to on or not. If it is on, then thread A will decode the current movie file and play back the movie; otherwise, it will do nothing. When the decoding and playback continue, some reconstructed P frames will be saved for fast backward functions. After finishing playback, the playback mode will be set to off. The right side of FIG. 8 shows the work of thread B, which accepts control information from the end users. When a play command is received, it will call the play function of thread A and play the movie. When a stop command is received, the current movie will be stopped and the file pointer will be moved to the start of the movie. When a pause command is received, the current movie is paused at the current position. When a fast forward command is received, if the customer wants to fast forward to an I frame, then the information is available in the local disk. However, if the customer wants to fast forward to a P or B frame, then the client player needs to fetch one or two reconstructed frames from the media server. When a fast backward command is received, a reconstructed P frame or an I frame is obtained to start the decoding process. When an exit command is received, thread A and B are terminated and the client player exits.

Random frame search is the ability of a video player to relocate to a different frame from the current frame. Since the video frames are typically organized in a one-dimensional sequence, random frame search can be classified into fast forward (FF) and fast backward (or rewind REW).

If every frame in a video sequence is independently encoded using I-frames for example, then the player (decoder) would be able to jump to an arbitrary frame and resume the decoding and play from there. In a video sequence with all frames as I-frames, every frame can serve as a starting point of a new video sequence in FF and REW functions. However, due to the low compression rate associated with I-frames, very few systems, such as MJPEG, use this type of method.

In the MPEG family, predicted frames (P-frames) and bi-directional frames (B-frames) are used to achieve higher compression. Since the P-frames and B-frames are encoded with the information from some other frames in the video sequence, they cannot be used as the starting point of a new video sequence in FF and REW functions.

The MPEG family supports the FF and REW functions by inserting I-frames at fixed intervals in a video sequence. Upon a FF or REW request, the client player will locate to the nearest I-frame prior to the desired frame and resume the playing from there. The following shows a typical MPEG video sequence, where the interval between a pair of I-frames is 16 frames:
I BBBPBBBPBBBPBBB I BBBPBBBPBBBPBBB I

However, I-frames usually have a lower compression ratio than P and B frames. The MPEG family provides a tradeoff between the compression performance and VCR functionality.

The present invention keeps two sequences for a given video archive on the media server. One sequence, called the streaming sequence can provide the data for normal transmission purposes. Another sequence, the index sequence can provide the data for realizing FF and REW functions.

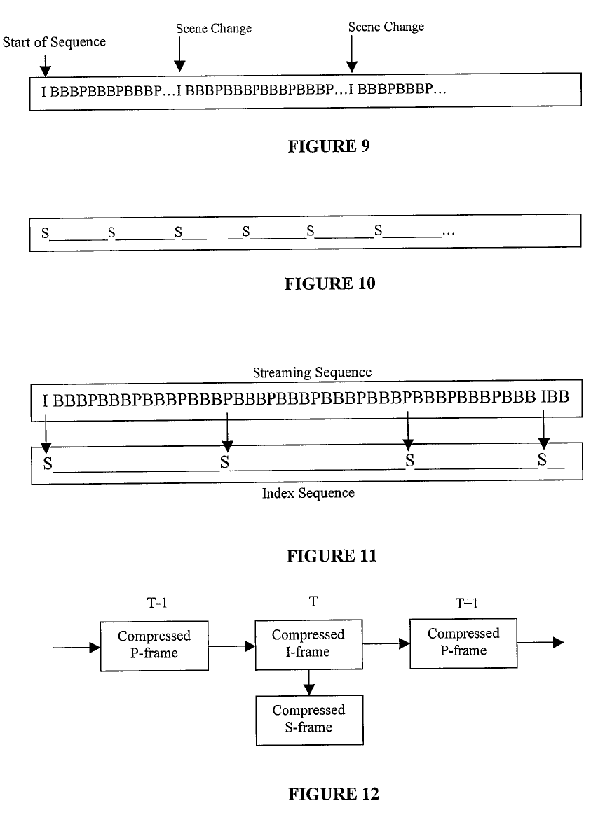

The streaming sequence starts with an I-frame, and contains I-frames only at places where scene changes occur wherein this concept is shown in FIG. 9.

The index sequence contains searchable index frames (S-frames) to support the FF and REW functions, as shown in FIG. 10. The interval between a pair of S-frames can be variable, and is determined by the requirement of the accuracy of a random search.

During the encoding process, the streaming sequence can be coded as the primary sequence, and the index sequence can be derived from the streaming sequence. An S-frame in the index sequence can be derived either from an I-frame or from a P-frame of the streaming sequence, but not from a B-frame. This feature is illustrated in FIG. 11.

The process of deriving an S-frame from an I-frame is illustrated in FIG. 12. The present invention copies the compressed I-frame data into the buffer of the S-frame.

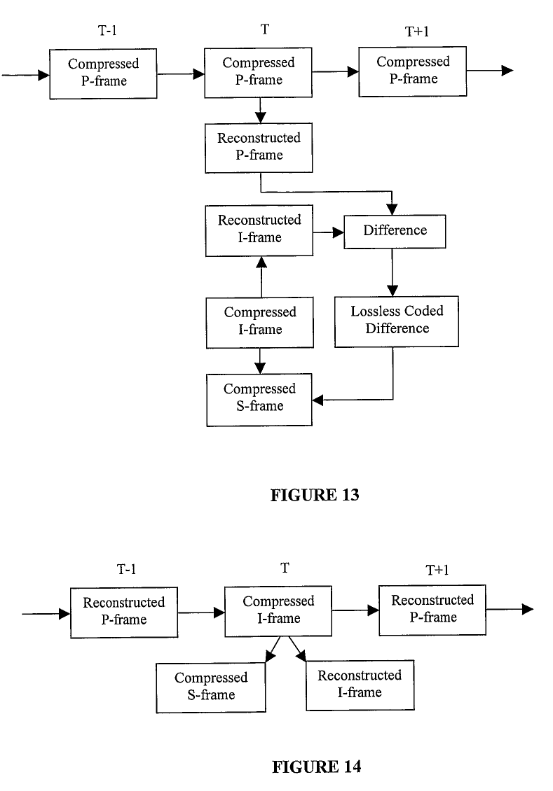

FIG. 13 shows how an S-frame is derived from a P-frame. Firstly, the reconstructed form of this P-frame is needed, and it can be acquired from the feedback loop of the normal P-frame encoding routine. Secondly, an I-frame encoding routine is called to encode this same frame as an I-frame, and one must keep both its compressed form and its reconstructed form.

Then, the difference between the reconstructed P-frame and the reconstructed I-frame is calculated. This difference can be encoded through a lossless process. The lossless-encoded difference, together with the compressed I-frame data, forms the complete set of data of the S-frame.

Similar to the encoding process, the decoder needs to derive an index sequence while decoding the streaming sequence. Same as the encoding process, an S-frame in the index sequence can be derived either from an I-frame or from a P-frame of the streaming sequence, but not from a B-frame. The decoder may not necessarily need to produce the S-frames at the same locations in the sequence as the encoding process.

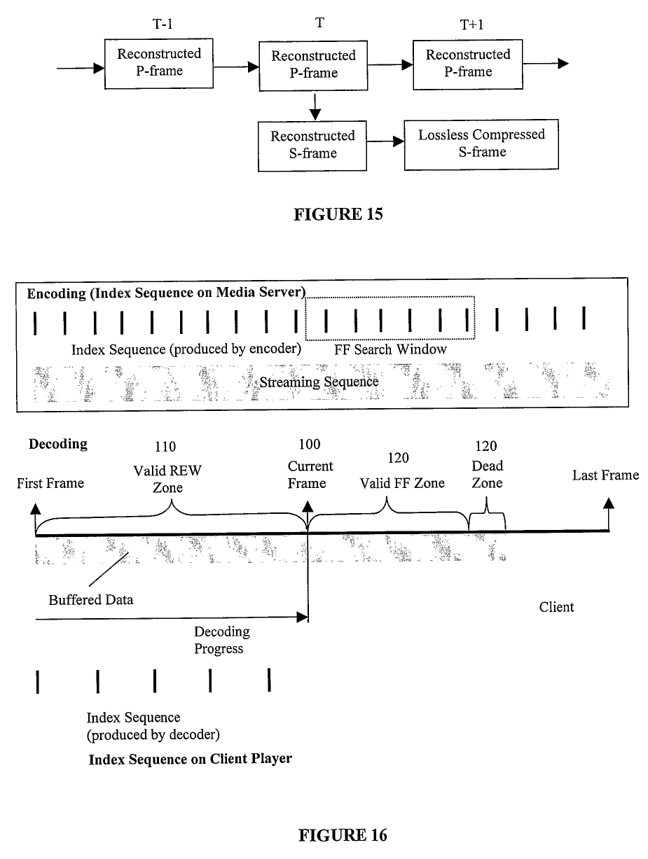

FIG. 14 shows the derivation of an S-frame from an I-frame in decoding while FIG. 15 illustrates the derivation of an S-frame from a P-frame.

The S-frame derived from an I-frame can be saved in compressed form, whereas the S-frame derived from a P-frame can be saved in reconstructed form. Since the reconstructed form requires much larger storage space than the compressed form does, this system uses two approaches to save the space required by P-frame derived S-frames: namely (1) the present invention can use a lossless compression step to save the reconstructed S-frames, which can in average reduce the required space by 50%. (2) the present invention can produce a sparser index sequence that can be created during the encoding process.

In one embodiment of the present invention, in a live broadcast environment a client player can require a minimum latency of 1 second to change channels, for example the time required to join a new data stream. In order to enable this type of feature it can be required that the video stream would have at least one I-frame every second. Since I-frames are inherently larger than P-frames, it is undesirable to have a fixed insertion rate for I-frames. Therefore, using the aforementioned S-frame technique, a live broadcast environment can use a natural encoding system, for example using I-frames for scene changes, and automatically generating a S-frame every second on a paired S-frame stream. In this manner the client player can automatically rejoin the normal channel stream in the middle of a P-frame sequence and continue decoding without any errors, for example.

In the streaming process, the encoded streaming sequence stored on the media server is transmitted to the client player.

The client player decodes the received streaming sequence, and at the same time produces an index sequence and stores it in a local storage device associated with the player.

FIG. 16 illustrates the method by which the FF and REW functions are achieved with the present invention. Suppose the decoding process is currently at the place of ‘Current Frame’ 100. Because this is a streaming application, the current frame is placed somewhere within the buffered data range. In general, this situation defines two searching zones for random frame access. The Valid REW Zone 110 starts with the first frame and ends at the current frame, and the Valid FF zone 120 is from the current frame to the front end of the buffered data range. In practice, the present invention defines a Dean Zone 130 at the front end of the buffered data range for the sake of smooth play of the video after the FF search operation has been performed.

When the client player receives a user request for a FF operation, it first checks to see if the wanted frame is within the valid FF zone. If yes, the wanted frame number is sent to the media server. The media server can locate the S-frame that is nearest to the wanted frame and send the data of this S-frame, in a compresses format to the client. Once this data is received, the client player decodes this S-frame and plays it. The playing process can then continue with the data in the buffer.

When a REW request is received by the client player, it will first check the local index sequence to see if a ‘close-enough’ S-frame can be found. If yes the nearest S-frame can be used to resume the video sequence. If no, a request is issued to the media server to download an S-frame that is nearest to the wanted frame.

In both FF and REW operations, the downloaded S-frame is stored in client player's local storage after it is used in order to resume a new video sequence.

This random search technique is referred to as being ‘distributed’ because both the media server and the client player provide partial data for the index sequence. Given a specific FF or REW request, the wanted S-frame could be found either in the local index sequence of the client player or in the media server's index sequence. At the end of the play process, the end user can have a complete set of S-frames stored on their client player for later review purposes. Therefore, when the viewer watches the same video content for the second time, all FF and REW functions will be available locally.

In one embodiment a storyboard is generated, wherein a story board is a short, for example 2 or 3 minute, summary of a movie, which shows the important pictures of a feature length movie. People may want to get a general idea of a movie before ordering. The SVOD system according to the present invention can allow the viewers to preview the storyboard of a movie to decide whether to order it or not. Another advantage of the storyboard is to allow viewers to fast forward/backward by storyboard unit instead of frame by frame. Moreover, some indexing can be utilized based on the storyboard and intelligent retrieval of movies can be realized.

In one embodiment, the generation of a storyboard involves three steps. First, some scene change techniques are applied to segment a long movie into shorter video clips. After that, key frames are chosen from each video clip based on some low or medium level information, such as color, texture, or important objects in the scene or other features, for example. Subsequently, a higher-level semantic analysis can be applied to the segmented clips to group them into meaningful story units, if desired. When a customer wants to get a general idea of a certain movie, they can quickly browse the story units and if they are interested, they can dig into details by looking at key frames and each of the video clips.

Scalability is a very desirable option in a streaming video application. Current streaming systems allow temporal scalability by dropping frames, and cut the wavelet bit-stream at a certain point to achieve spatial scalability. The present invention offers another scalability mode, which is called SNR and spatial scalability. This kind of scalability is very suitable for streaming video, since the videos are coded in base layer and enhancement layers. The server can decide to send different layers to different clients. For example, if a client requires high quality videos, the server can send base layer stream and enhancement layer streams. Otherwise, when a client only wants medium quality videos, the server can just send the base layer to it. The video player can also be able to decode scalable bit-streams according to the network traffic. Normally, the video player would display the video stream that the client asks for, however, for example when the network is busy and the transmission speed is very slow, the client player can notify the upstream server to only send the base layer bit-stream to relieve the network load.

After processing of the movie clips, scene change information and key frames are available, which can be used to populate the movie database. Keywords, as well as visual content of key frames, can be used as indices to search for the movies of interest. Keywords may be assigned to movie clips by computer processing with human interaction. For example, the movies can be categorized into comedy, horror, scientific, history, music movies or others. The visual content of key frames, such as color, texture, and objects, can be extracted by automatic computer processing. Color and texture can be dealt with in a relatively easy manner, however a more difficult task is how to extract objects from a natural scene. This population process can be automatic or semi-automatic, where a human operator may interfere.

After populating, another embodiment of the present invention may allow customers to search for the movies they would like to watch. For example, they can specify the kind of movies, such as comedy, horror, or scientific movies. They can also choose to see a movie with certain characters they like, or movies having other desired characteristics. The intelligent retrieval capability can allow a client to find the movies they like in a shorter time, which can be important for the customers.

Multicasting can also be a feature of streaming video. This feature can allow multiple users to share the limited network bandwidth. There are some scenarios that multicasting can be used with another embodiment of the present invention. The first case is a broadcasting program, where the same content is sent out at the same time to multiple customers. The second case is a pre-chosen program, where multiple customers may choose to watch the same program around the same time. The third case is when multiple customers order movies on demand, some of them happen to order the same movie around the same time. Multicasting can allow the media server to send one copy of an encoded movie to a group of customers instead of sending one copy to each of them. This type of feature can increase the server's capability and can make full use of network bandwidth, for example.

It would be readily understood to a worker skilled in the art how to design a computing system for each of the media server, web server and client player in order to provide the functionality identified above. As would be readily understood, the functionality of the media server and web server can be provided by a single computing system or optionally can be provided by a collection of computing systems.

The following table provides an estimation of the compression performance achieved with one embodiment of the present invention, wherein 2 Mbps channel bandwidth is assumed and wherein these estimations are based on frame size of 320×240 at 30 frames/sec.

TABLE 1

| 100-min | DVD | | | | | |
|---|---|---|---|---|---|---|
| Movie | quality (20:1) | | VCD quality (40:1) | | DAC quality (80:1) | |
| (Raw Data | Data | Download | Data | Download | Data | Download |
| Size) | Size | Time | Size | Time | Size | Time |
| 19775 M | 989 | 3956 Sec | 495 M | 1980 Sec | 248 M | 992 Sec |
| | M | | | | | |

The following table provides system specifications according to one embodiment of the present invention.

TABLE 2

| | | | | Transfer | |
|---|---|---|---|---|---|
| Bandwidth | Server | Presentation | Server | Control | Transfer |
| (Client) | Capability | Delay | Network | Protocol | Protocol |
| 1.5 Mbps | 1.5 Gbps | 6 Minutes | Fiber/ATM | RTSP | RTP |

| Fast | Pause/ | Sto- | Scal- | Intelligent | High quality, | |
|---|---|---|---|---|---|---|
| Forward/ | Stop/ | ry- | abil- | Movie | smooth | Multi- |
| Backward | Play | board | ity | Retrieval | playback | casting |
| Yes | Yes | Yes | Yes | Yes | Yes | Yes |

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A video-on-demand system enabling a user to modify play parameters of a selected video signal, said system comprising:
(a) a media server for transmitting the selected video signal, said media server generating a first series of searchable index frames during transmission of the selected video signal, said media server storing said first series thereon;
(b) a client player for receiving and displaying the selected video signal, said client player generating and storing a second series of searchable index frames thereon, said client player accessing said first series or said second series and obtaining a required searchable index frame therefrom upon receipt of a request by the user to modify the play parameters, said required searchable index frame providing a new starting point for display of the selected video signal, said media server and said client player being operatively connected by a communication network.

2. The video-on-demand system according to claim 1, further comprising a video database operatively coupled to said media server, said video database comprising a plurality of videos selectable by the user.

3. The video-on-demand system according to claim 2, wherein said videos in the video database are in an encoded format.

4. The video-on-demand system according to claim 2, further comprising a feature database operatively coupled to said media server, said feature database comprising a plurality of extracted features, wherein one or more of the plurality of extracted features are associated with one of the videos in the video database.

5. The video-on-demand system according to claim 4, wherein said plurality of extracted features provide a means for said user to search and identify a video for subsequent display based on a desired criteria represented by one or more of the plurality of extracted features.

6. The video-on-demand system according to claim 4, wherein one or more of the plurality of extracted features is either a word identifier or an image identifier.

7. The video-on-demand system according to claim 4, wherein one or more of the plurality of extracted features is a movie clip representative of one of the videos in the video database.

8. The video-on-demand system according to claim 4, further comprising a video production module for encoding each of said videos into an encoded format.

9. The video-on-demand system according to claim 8, wherein said video production module further generates said extracted features.

10. The video-on-demand system according to claim 1, further comprises a user account management module for providing a means for controlling user access.

11. A method for enabling a user to modify play parameters of a selected video signal in a video-on-demand system, said method comprising the steps of:
(a) establishing a connection between a media server and a client player;
(b) receiving by said media player, a request for the selected video signal from said client player;
(c) transmitting by said media player, said selected video signal to the client player;
(d) generating and storing a first series of searchable index frames by the media player while transmitting;
(e) receiving and displaying said selected video signal by the client player;
(f) generating and storing a second series of searchable index frames by the client player while receiving and displaying;
(g) receiving by the client player, a request to modify play parameters of the selected video signal from the user;
(h) searching said first series or second series for a required searchable index frame, said required searchable index frame providing a new starting point for displaying said selected video signal;
(i) displaying said selected video signal from said new starting point;
(j) terminating said connection between a media server and a client player upon completion of display of the selected video signal.

12. The method according to claim 11, wherein prior to step b performing the steps of:
(aa) searching a feature database by a user, said feature database comprising a plurality of extracted features, wherein one or more of the plurality of extracted features are associated with one of a plurality of videos in a video database;
(bb) selecting by the user a desired video from the video database based on one or more of the plurality of extracted features;
(cc) transmitting the request for the selected video signal from the client player.

13. The method according to claim 12, wherein prior to step a) performing the step of authenticating the user.

14. The method according to claim 13, wherein prior to step of authenticating the user, performing the steps of:
(a) encoding a plurality of videos for subsequent transmission;
(b) saving said encoded videos in the video database;
(c) identifying one or more extracted features for each of the plurality of videos;
(d) saving said extracted features in a searchable configuration in the features database.

15. The method according to claim 11, wherein the media server is connected to a plurality of client players.
